(19) United States
(12) Patent Application Publication
(10) Pub. No.: US 2018/0158124 A1
(43) Pub. Date: Jun. 7, 2018

(54) Determining and Producing Customized Paint Colors

(71) Applicant: PPG Industries Ohio, Inc., Cleveland, OH (US)

(72) Inventors: Christopher Caruso, Pittsburgh, PA (US); Kevan M. Farley, Monroeville, PA (US); Phillip J. Behrens, McDonald, PA (US)

(21) Appl. No.: 15/575,474

(22) PCT Filed: May 19, 2016
(86) PCT No.: PCT/US2016/033309

§ 371 Date: Nov. 20, 2017

Related U.S. Application Data
(60) Provisional application No. 62/165,778, filed on May 22, 2015.

(51) Int. Cl. G06Q 30/06

(52) U.S. Cl. CPC G06Q 30/0621; G06Q 30/0627; G06Q 30/0643

(57) ABSTRACT

The present invention is directed to determining a desired color for a home project and producing paint having the desired color through a kiosk at a point of sale location corresponding to a retail establishment, and to determining a desired color for a home project and producing paint having the desired color. In one scenario, a computer system receives from a user an indication of a particular paint color. The computer system displays to the user a representation of the color corresponding to the indication of color. The computer system further receives user input directed to altering the displayed color, alters the displayed color based on the user input until the desired color is displayed, determines a unique tint formula corresponding to the desired color, and produces a paint code that can be used to create a paint having the desired color based on the tint formula.

### BACKGROUND

Many homeowners upgrade the look of their homes by doing home projects. In a majority of these projects the homeowner paints one or more rooms. In particular, the walls, ceiling, doors, etc. can be earmarked for a new coat of paint. The homeowner may have an idea of the colors to use, but must determine exact colors before he can buy paint to do the job.

Traditionally, the homeowner has had to travel to the paint store to obtain one or more paint chips, take those paint chips home to compare with existing paint colors and/or colors of home décor items within the home, and then decide on which paint color to use. Many times the homeowner will decide that none of the paint chip colors are acceptable. In that case, the homeowner must obtain different paint chips from the paint store to begin the process anew. This process is very inefficient.

Often the homeowner wants to use a color that is not found on any of the paint chips available from the paint store. For example, the desired color might be somewhere between the colors of two adjacent paint chips. Conventionally, the homeowner can have a store representative customize a paint color based on the closest paint chips. This is done by modifying the tint colors and amounts added to the paint base. Although the store representative might be experienced in doing this, it still can require some guessing on his or her part. Thus, while this might lead to a paint having the desired color, it can just as often produce a color that is not. Even if the paint color is close to the desired color, it may be slightly different—enough so that the color clashes with home décor items or other paint colors in the home.

### BRIEF SUMMARY

The present invention is directed to determining a desired color for a home project and producing paint having the desired color through a kiosk at a point of sale location corresponding to a retail establishment and to determining a desired color for a home project and producing paint having the desired color. The present invention can include a computer system configured to receive from a user an indication of a particular paint color. The computer system displays to the user a representation of the color corresponding to the indication of color. The computer system further receives user input directed to altering the displayed color, alters the displayed color based on the user input until the desired color is displayed, determines a unique tint formula corresponding to the desired color, and produces a paint code that can be used to create a paint having the desired color based on the tint formula.

The present invention also provides a system for determining a desired color for a home project and producing paint having the desired color. The system includes a computerized device for positioning at a kiosk at a point of sale location corresponding to a retail establishment. The computerized device includes a display and an input device, where the computerized device is adapted to perform the following: determine a paint color associated with a received paint color indicator, determine a display color that accurately represents the paint color associated with the received paint color indicator, display the display color on the display, receive user input via the input device directed to altering the displayed color and to indicating when a desired color is displayed, alter the displayed color based on the user input until the desired color is displayed, and determine a tint formula corresponding to the desired color. The system also includes a paint mixer in electronic communication with the computerized device, where the paint mixer is adapted to electronically receive the tint formula from the computerized device and produce a paint code corresponding to the desired color based on the received tint formula.

The present invention also provides a kiosk computer system. The kiosk computer system includes one or more processors, a receiving module for receiving from a user at the kiosk, an indication of a particular paint color, a display for displaying to the user a representation of the color corresponding to the indication of color, an input device for receiving user input directed to altering the displayed color, a color altering module for altering the displayed color based on the user input until the desired color is displayed, a tint formula determining module for determining a tint formula corresponding to the desired color, and a paint code producing module for producing a paint code that can be used to create a paint having the desired color based on the tint formula.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of the present invention may be realized and obtained by means of the instruments and combinations particularly pointed out in the appended claims. Features of the present invention will become more fully apparent from the following description and appended claims.

### BRIEF DESCRIPTION OF THE DRAWINGS

To further clarify the above and other features of the present invention, a more particular description will be rendered by reference to the appended drawings. It is appreciated that these drawings depict only examples of the present invention and are therefore not to be considered limiting of its scope. The present invention will be described and explained with additional specificity and detail through the use of the accompanying drawings in which:

FIG. 1 illustrates a computer architecture in which the present invention may operate including determining a desired color for a home project and producing paint having the desired color through a kiosk at a point of sale location corresponding to a retail establishment.

FIG. 2 illustrates a flowchart of an example method for determining a desired color for a home project and producing paint having the desired color through a kiosk at a point of sale location corresponding to a retail establishment.

FIG. 3 illustrates a flowchart of an example method for determining a desired color for a home project and producing paint having the desired color.

FIG. 4 illustrates a kiosk that includes a display and user input devices.

FIG. 5 illustrates a kiosk display that facilitates determination of a desired color for a home project.

### DETAILED DESCRIPTION

The present invention are directed to determining a desired color for a home project and producing paint having the desired color through a kiosk at a point of sale location corresponding to a retail establishment and to determining a desired color for a home project and producing paint having the desired color. In one example, a computer system receives from a user an indication of a particular paint color. The computer system displays to the user a representation of the color corresponding to the indication of color. The computer system further receives user input directed to altering the displayed color, alters the displayed color based on the user input until the desired color is displayed, determines a unique tint formula for a specific base paint formula corresponding to the desired color, and produces a paint code that can be used to create a paint having the desired color based on the tint formula.

The present invention may also provide a system for determining a desired color for a home project and producing paint having the desired color. The system includes a computerized device for positioning at a kiosk at a point of sale location corresponding to a retail establishment. The computerized device includes a display and an input device, where the computerized device is adapted to perform the following: determine a paint color associated with a received paint color indicator, determine a display color that accurately represents the paint color associated with the received paint color indicator, display the display color on the display, receive user input via the input device directed to altering the displayed color and to indicating when a desired color is displayed, alter the displayed color based on the user input until the desired color is displayed, and determine a tint formula corresponding to the desired color. The system also includes a paint mixer in electronic communication with the computerized device, where the paint mixer is adapted to electronically receive the tint formula from the computerized device and produce a paint code corresponding to the desired color based on the received tint formula.

The present invention also provides a kiosk computer system. The kiosk computer system includes one or more processors, a receiving module for receiving from a user at the kiosk, an indication of a particular paint color, a display for displaying to the user a representation of the color corresponding to the indication of color, an input device for receiving user input directed to altering the displayed color, a color altering module for altering the displayed color based on the user input until the desired color is displayed, a tint formula determining module for determining a tint formula corresponding to the desired color, and a paint code producing module for producing a paint code that can be used to create a paint having the desired color based on the tint formula.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

The present invention may implement various types of computing systems, and may use these computing systems to perform computerized methods. These computing systems are now increasingly taking a wide variety of forms. Computing systems may, for example, be handheld devices such as smartphones or feature phones, appliances, laptop computers, tablets, wearable devices, desktop computers, mainframes, distributed computing systems, or even devices that have not conventionally been considered a computing system.

In this description and in the claims, the term “computing system” is defined broadly as including any device or system (or combination thereof) that includes at least one physical and tangible hardware processor, and a physical and tangible hardware or firmware memory capable of having thereon computer-executable instructions that may be executed by the processor. A computing system may be distributed over a network environment and may include multiple constituent computing systems.

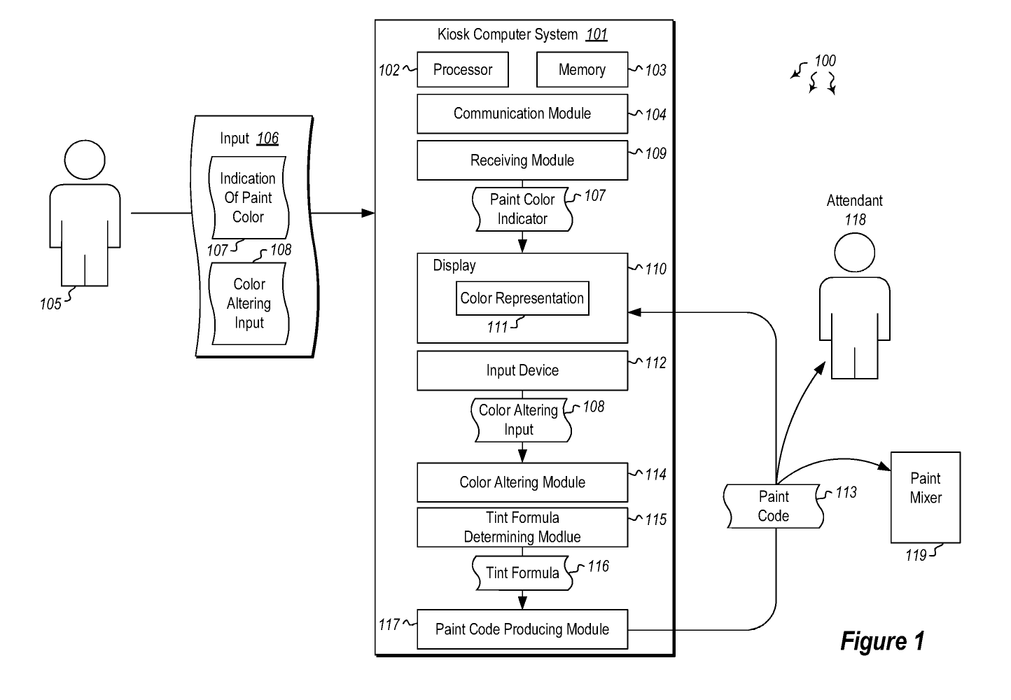

As illustrated in FIG. 1, a kiosk computing system 101 may include at least one processing unit 102 and memory 103. The memory 103 may be physical system memory, which may be volatile, non-volatile, or some combination of the two. The term “memory” may also be used herein to refer to non-volatile mass storage such as physical storage media or physical storage devices. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, the present invention is described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media or computer-readable hardware storage devices that form a computer program product.

An example of such an operation involves the manipulation of data. The computer-executable instructions (and the manipulated data) may be stored in the memory 103 of the computing system 101. Kiosk computing system 101 may also contain communication channels that allow the computing system 101 to communicate with other message processors over a wired or wireless network. Such communication channels may include hardware-based receivers, transmitters or transceivers, which are configured to receive data, transmit data or perform both.

The present invention may comprise or utilize a special-purpose or general-purpose computer system that includes computer hardware, such as, for example, one or more processors and system memory, as discussed in greater detail below. The system memory may be included within the overall memory 103. The system memory may also be referred to as “main memory”, and includes memory locations that are addressable by the at least one processing unit 102 over a memory bus in which case the address location is asserted on the memory bus itself. System memory has been traditionally volatile, but the principles described herein also apply in circumstances in which the system memory is partially, or even fully, non-volatile.

The present invention also include physical and other computer-readable media for carrying or storing computer-executable instructions and/or data structures. Such computer-readable media can be any available media that can be accessed by a general-purpose or special-purpose computer system. Computer-readable media or storage devices that store computer-executable instructions and/or data structures are computer storage media or computer storage devices. Computer-readable media that carry computer-executable instructions and/or data structures are transmission media. Thus, by way of example, and not limitation, the present invention may comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the present invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

FIG. 1 illustrates a computer architecture 100 in which the present invention may be employed. Computer architecture 100 includes kiosk computer system 101 (or simply “kiosk 101” herein). Kiosk computer system 101 may be any type of local or distributed computer system, including a cloud computing system. The kiosk computer system 101 includes modules for performing a variety of different functions. For instance, the communications module 104 may be configured to communicate with other computing systems. The communications module 104 may include any wired or wireless communication means that can receive and/or transmit data to or from other computing systems. The communications module 104 may be configured to interact with databases, mobile computing devices (such as mobile phones or tablets), embedded or other types of computing systems.

The kiosk computer system 101 may further include a receiving module 109. The receiving module 109 may receive input 106 from a user 105. The input 106 may include a paint color indicator 107 and/or a color altering input 108. The paint color indicator 107 may be anything that could indicate or describe or suggest a paint color. The paint color indicator can be input into the kiosk computer system 101 via a barcode reader (scanner), quick response (QR) code reader, via user input via a mouse or keyboard (i.e. the user can click on the color they like, or the user could type in the paint's name or ID code), via a color spectrophotometer that determines the color of an object such as carpet, or the color could be uploaded to the kiosk computer system from a picture or image. Other ways of providing a paint color indicator may also be used.

The paint color indicator may include a paint name, a paint swatch, a sample of carpet or stain or wallpaper, a color from a painting or image, a color from a home décor item or any other item, number, code or identifier that would identify or could be used to identify a paint color. The paint may be used on a home project, such as an indoor or outdoor paint project. Any information related to that project may be referred to herein as “project information”. This project information may include any type of data related to a specified home or business project. A home or business project may include remodeling, repainting, redecorating, adding or removing spaces or even building a new home or office.

The project information may thus include materials, timelines, home décor objects including artwork or furniture, budget information, amount of area that will be painted or repainted, or any other information related to a work that is to be performed on a house, office or other spaces including outdoor spaces. Specifically, in the present invention, the project information may be related to remodeling or repainting projects where a user (e.g. 105) is repainting one or more rooms and is using the kiosk computer system 101 to customize a paint color to use on a project or color coordinate a paint color with other home décor items, or find home décor items that match a certain paint color. In such cases, the kiosk computer system could access the project information and calculate the size of area to be painted and the amount of paint needed to paint the project.

Upon receiving the paint color indicator 107, the display 110 of the kiosk computer system 101 may display a color that is determined to match or substantially correspond to the indication of color. Thus, if a user provides a carpet sample or paint chip, the kiosk will determine which color representation 111 it determines best represents the indicated color 107. To make this determination, the kiosk computer system 101 associates the paint color indicator with a color in a color palette (i.e. a database with a set amount of preselected and stored colors). The colors in the color palette are associated with a predetermined paint tint formulation. Then the user will adjust the paint to a desired color that may or may not be within the paint color palette. The user may then view the determined color on the display 110 of the kiosk. At this point, the user 105 may determine that the color representation 111 does not match the color indicator 107 and may adjust the color to a desired color.

For instance, the color representation may be lighter or darker or a different hue or even a different color than the color indicator 107. The user 105 may then provide a color altering input 108 that alters the color representation 111 to look more like the color indicator 107 or to look more like a color the user desires which may not be the exact color of the input color. For example, the color altering input may cause the color altering module 114 to lighten or darken the color representation 111. Additionally or alternatively, the color altering input 108 may cause the color altering module 114 to modify the hue of the color representation 111 by increasing its red, blue or green values. It will be understood that many different shading and coloring techniques may be used to alter the color of the color representation 111.

Once the user 105 has altered the color representation 111 to a desired color, the tint formula determining module 115 may generate a unique tint formula 116 that can be applied to a base paint to create the user customized color representation. The tint formula may provide a specified amount of coloring that is to be applied to the base paint to color it in the manner specified by the user 105. In some cases, the tint formula 116 devised by the tint formula determining module 115 is specific to a certain brand of base paint or to a certain family of brands or to certain types of paints. Each paint manufacturer may have their own unique and proprietary formula for creating a base paint. As such, when tints are applied to different manufacturers' base paints, the tints may produce slightly different colors. Thus, when the tint formula determining module 115 determines a tint formula to create a desired color, the tint formula is a unique formula that only works with a specific manufacturer's base paint formula.

In some cases, the manufacturer of the kiosk 101 may partner with a paint manufacturer to create and sell customized paints using its base paint. Alternatively, the paint manufacturer itself may produce the kiosk 101, which generates tint formulas that work specifically with its brand of base paint. The tint formula 116 may be provided to the paint code producing module 117, which itself generates a paint code 113 that represents the user-selected color representation and a tint formula that can be used to create the user-selected color of paint. This paint code may be sent to the kiosk display 110 for display to the user 105, may be sent to an attendant in a retail establishment's paint area so that the attendant 118 can mix the paint using the code, or may be sent to a paint mixer 119 directly for production of the customized paint. The paint code 113 may be any type of name, number or other identifier that precisely indicates which color of paint to create.

In some cases, the attendant may mix the paint manually or initiate a mixer to mix the paint, or the paint code may be sent directly to an automated mixer that combines the colors with the base paint to generate the user-customized color. As the term is used herein, a “mixer” may refer to a tinting machine that applies the proper amount of tint to the paint to create the desired color. The paint can is then sealed and shaken until mixed. The mixer may perform the tinting operation, the sealing and shaking operation, or both.

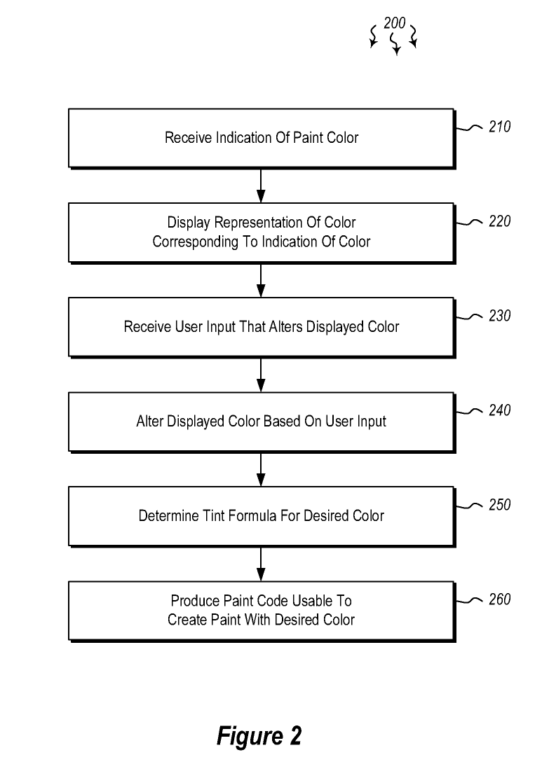

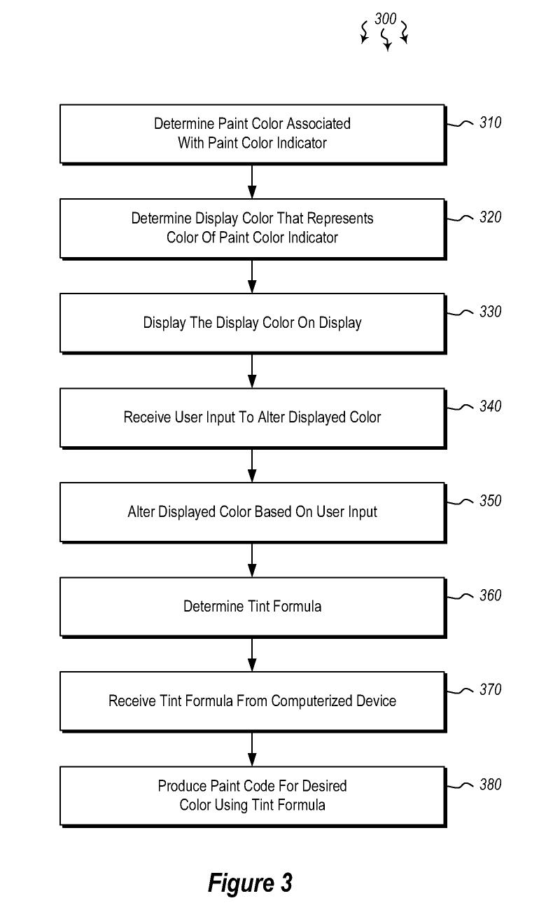

Thus, in this manner, a user 105 may bring a paint chip, paint swatch, carpet or flooring sample, home décor item or any other object with which they wish to match a paint color. The user may match this color on the kiosk by altering a selected color until the match is acceptable to the user. Then, once the color has been selected and customized, the user may have virtually any quantity of paint produced in that color. Moreover, the generated paint code 113 may be stored in the user's kiosk profile so that if the user wants to produce more paint of that color at some future point in time, the kiosk will simply be able to provide the code to the attendant 118 or paint mixer 119. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for determining a desired color for a home project and producing paint having the desired color through a kiosk at a point of sale location corresponding to a retail establishment. The method 200 will now be described with frequent reference to the components and data of environment 100.

Method 200 includes receiving from a user at the kiosk, an indication of a particular paint color (210). For example, receiving module 109 may receive an paint color indicator 107 from user 105. The indication may be received in a variety of manners, including the user providing an image of a color, the user providing a carpet or flooring sample which is scanned by the kiosk for a color, the user providing a link to their profile where images or color information is stored, the user providing a product where the product's bar code is scanned and the color is determined based on the scan, or the user simply selecting a color from a variety of selectable colors. It will be understood that other ways of indicating a color may also be used.

The paint color indicator itself 107 may be a paint chip, a color swatch, an image, a specified color within an image, a home décor item or any other item that could indicate color. In cases where the paint color indicator 107 is a paint chip, the paint chip may be one of a plurality of paint chips that are specific to a single paint manufacturer. In such cases, the kiosk may use the base paint of that manufacturer in creating the customized paint color for the user.

Method 200 also includes displaying to the user on a kiosk display a representation of the color corresponding to the indication of color (220). As shown in FIG. 1, color representation 111 may be displayed on display 110 of kiosk computer system 101. The color representation 111 may be a color identified by the kiosk as matching or being substantially similar to the indicated color 107. The display color 111 and the desired color may be represented in red, green, blue (RGB) format.

Method 200 further includes receiving, by an input device of the kiosk, user input directed to altering the displayed color (230). The receiving module 109 of kiosk computer system 101 receives color altering input 108 that is designed to alter the color of the determined color representation 111. Indeed, the kiosk 101 may identify a display color that represents the particular paint color 111 associated with the paint color indicator 107. The color altering input may change the color representation 111 in a variety of different manners, including changing the shade of the color, the hue of the color, the intensity of the color or other characteristics of the color. The color altering module 114 then alters the displayed color based on the user input 108 until the desired color is displayed (240). This desired color may be a color that is not part of a predetermined color palette, and may be a truly customized color.

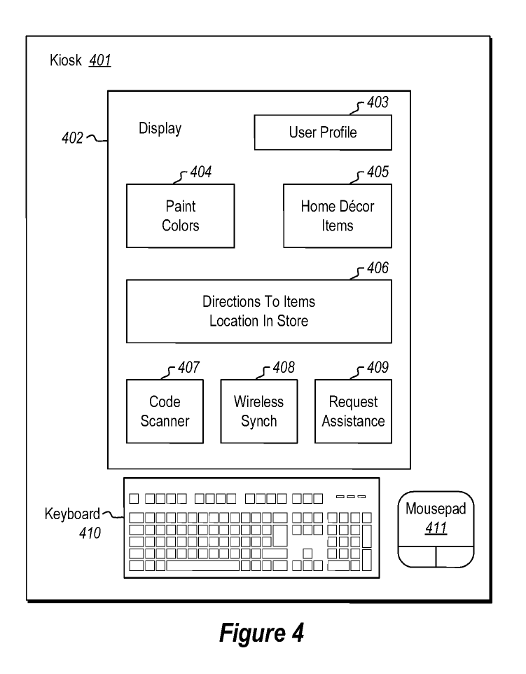

The user input may be supplied at the kiosk directly using hardware input devices, or may be provided wirelessly via Bluetooth or WiFi or some other wireless transport means. As shown in FIG. 4, a kiosk computer system 401 may include various hardware input devices including a mouse or mouse pad 411, a keyboard 410, a touchscreen 402 (or other type of display), a bar code or QR code scanner 407, a color spectrophotometer (not shown), and a wireless communication or synchronization device 408 that uploads images to the kiosk computer system. The code scanner may be used to scan a particular item's bar code and thereby input that item into the kiosk.

The kiosk can then analyze information related to that product and determine its color. The color spectrophotometer may be used to scan carpet or flooring samples or paint chips or other physical objects that the user wishes to color match. When paint colors 404 are determined, they may be shown in the display 402, along with any home décor items 405 that are determined to color match or otherwise correspond with the selected paint colors. The kiosk display may provide directions to these items' location in the store 406 if desired by the user. Any color indications provided by the user or tint formulas generated by the kiosk may be stored in the user's profile 403 for later reference.

Method 200 also includes determining, by the kiosk, a tint formula corresponding to the desired color (250), and producing, by the kiosk, a paint code that can be used to create a paint having the desired color based on the tint formula (260). The tint formula determining module 115 may determine a tint formula 116 that corresponds to the (potentially altered) color representation 111. The tint formula 116 is then passed to the paint code producing module 117 which generates a customized paint code 113 for the color representation 111. The paint code is provided to a store attendant 118 who then mixes the paint with the user's customized color, or is provided directly to a paint mixer 119 which is configured to mix the paint automatically using the tint formula 116. In some cases, the paint code 113 may also be sent to the display 110 and/or to the user's profile so that the user can view the paint code and save it for any subsequent uses of that paint color.

The kiosk computer system 101, of the present invention may associate a different display color with each of a plurality of paint color indicators 107. These display colors (i.e. color representations 111) are colors that, when displayed on the display 110, reproduce the paint colors of the corresponding paint color indicators. The color representation is intended to accurately represent the color indicator 107. However, as the representations may not always be accurate, the user may alter the representation using color altering input 108. Once the user makes any desired changes to the paint color, the selected color is associated with the user and stored in the user's profile for future paint production.

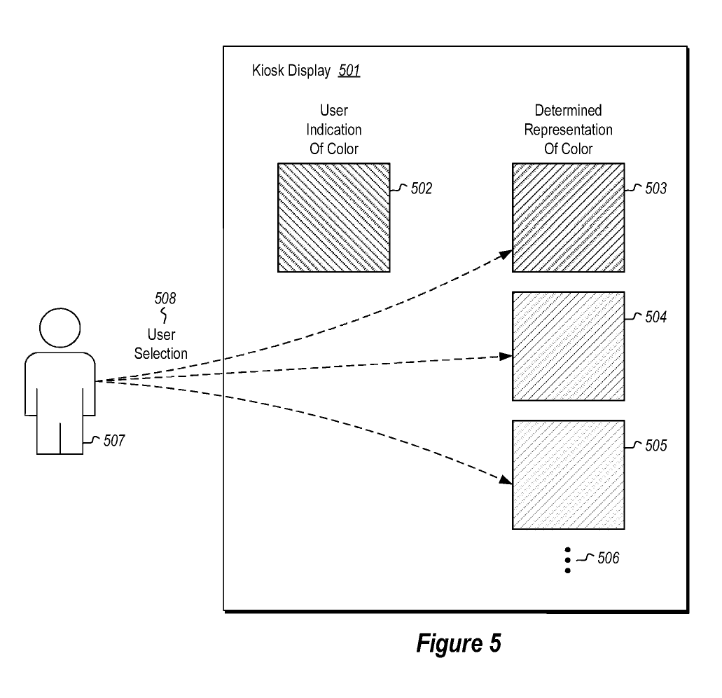

As shown in FIG. 5, a kiosk display 501 may show an indication of color 502 (which may be the same as color indicator 107) and a determined representation of color 503. Variants on the representation of color may also be shown alongside the representation of color 503. The variant 504 may be a shade lighter than representation 503, while the variant 505 may be a shade lighter than the variant 504. Many other variants may be shown as indicated by ellipses 506. The variants may include different hues, different intensities, or even different colors.

The user 507 may select 508 from the illustrated variants, or may dynamically alter the representation of color 503 by changing its shading, hue, intensity or other characteristic. In such cases, it is likely that only the indication of color 502 and the determined representation of color 503 will be shown on the kiosk display, and that the specified characteristics of the determined representation of color 503 will change as the user continues to provide color altering inputs. Thus, the user 507 may adjust characteristics of the determined representation of color 503 until it matches the indication of color 502, or until the user is satisfied with the representation of color. When the user 507 is finished adjusting the color of the representation 503, the other displayed representations may be removed from the kiosk display 501, and the finalized representation of color 503 may be enlarged so that the user gets an even better feel for their selected color. Further adjustments to the color may be made after this point if desired.

Returning to FIG. 1, once the color representation 111 is decided upon, the tint formula determining module 115 will identify a tint formula 116 that, when added to a base paint, will create a paint with the color in the representation 111. In some cases, the tint formula specified by the paint code may be determined based on an RGB code of the displayed color representation 111 that corresponds to the paint color indicator 107. The RGB code of the color representation 111 may provide a more precise indicator of the color shown in the representation, and may thus increase the likelihood that the tint formula will be accurate and that the resulting paint will be the color shown in the representation.

The paint code producing module 117 generates paint code 113 which may be sent to a paint station that prepares the paint according to the paint code. Producing this paint code 113 may include electronically transmitting the tint formula 116 to an automatic paint mixer 119 at the paint station, where the tint formula corresponds to the color representation 111. The paint mixer 119 then determines, based on the electronically received tint formula 116, colors and amounts of pigments to add to a base paint to produce paint having the desired color. The paint mixer then mixes the determined colors and amounts of pigments with the base paint to produce the paint having the desired color. In some cases, the paint mixer 119 may perform these functions automatically, while in other cases, an attendant assists in creating the paint. In some cases, the paint mixer 119 may be integrated into or may be part of the kiosk itself.

The paint code 113 may be valid for base paint types produced by multiple paint manufacturers, or may be specific to base paints made by a certain paint manufacturer, or may be specific to certain types of paints (e.g. solvent-based or water-based paints). Accordingly, the paint code 113 may electronically indicate to the paint mixer 119 which types of base paint it may be used with. In some cases, the paint manufacturer themselves may provide the paint kiosk 101 and, in such cases, the kiosk will output paint codes that work with base paints produced by the paint manufacturer. In this manner, a user may provide an indication of color, customize that color, and have the kiosk generate a paint code that will allow paint to be generated in the customized color.

Turning now to FIG. 3, a flowchart is illustrated of a method 300 for determining a desired color for a home project and producing paint having the desired color. The method 300 will now be described with frequent reference to the components and data of environment 100. The method may be performed by a system for determining a desired color for a home project and producing paint having the desired color, where the system includes a computerized device for positioning at a kiosk at a point of sale location corresponding to a retail establishment. The computerized device includes a display and an input device, where the computerized device is adapted to perform method 300.

Method 300 includes determining a paint color associated with a received paint color indicator (310). The determined paint color may be color representation 111, and the received color indicator may be indicator 107 received from user 105 in input 106. The user input may be received via input device 112, such as keyboard 410 or mouse pad 411 or a touchscreen display 402 of FIG. 4. The color representation may be determined using processor 102 of kiosk computer system 101. The processor may analyze the characteristics of the paint color indicator 107 and determine which color is indicated thereby. The processor may then generate a color representation 111 that is closest to the paint color indicator 107 found in a color palette or color database. Indeed, the processor may determine a display color that represents the paint color associated with the received paint color indicator (320). The representation is designed to be accurate, such that the indication of color and the representation of color are the same or substantially the same color, shade and intensity.

Method 300 further includes displaying the display color on the display (330). The display 110 of the kiosk computer system 101 may display the color representation 111, along with potentially other color representations (as generally shown in FIG. 5). The input device 112 may receive further user input 106 directed to altering the displayed color 111 and to indicating when a desired color is displayed (340). The input device 112 may thus receive color altering input 108 which alters one or more characteristics of the color representation including shading, hue or intensity. Changes to the color representation 111 may be made dynamically, and the user 105 may visually observe how the color representation changes in response to the color altering inputs 108. The user input 106 may also select a given color representation 111 once the user is satisfied with its color.

Method 300 also includes altering the displayed color based on the user input until the desired color is displayed (350) and determining a tint formula corresponding to the desired color (360). A paint mixer 119 of the system which is in electronic communication with the computerized device may electronically receive the tint formula from the computerized device (370) and produce a paint code corresponding to the desired color based on the received tint formula (380). Thus, in some cases, once a user has selected a given color representation 111, the tint formula determining module 115 may generate a tint formula 116 that identifies dyes and colors that, when mixed with a base paint, will create paint in the color of the selected representation 111. The paint code producing module 117 (which may be part of the kiosk 101 or part of the paint mixer 119) may generate a paint code 113 based on the tint formula 116 and use the paint code to make the paint.

The present invention may provide a database (such as a cloud data store) that associates desired colors with corresponding users. Indeed, as shown in FIG. 4, each kiosk user may have a user profile 403. When a user creates a customized color, that color may be stored in their user profile. The corresponding paint code 113 may also be stored in the user profile for later use. The database may also associate display colors (e.g. 111) with corresponding paint color indicators (e.g. 107), where the display colors are different colors that, when displayed on the display, reproduce the paint colors of the corresponding paint color indicators. Thus, if future users bring a similar color sample or other similar color indicator 107, the kiosk will associate the current color representation 111 selected by the user as a possible color representation for the future user's home project.

The database may further associate certain paint codes with certain paint manufacturers. Thus, at least in some cases, each paint code 113 may be valid for paint produced by a specified paint manufacturer. In other cases, a paint code is valid for a certain class of paints such as solvent-based paints or water-based paints. Still further, a paint code may be valid for a certain grouping of paints, including those paints that have a certain characteristic or ingredient or quality standard. Thus, in this manner, a user may use a kiosk system that has computerized means to receive user input identifying a color, display a similar (or same) color and allow the user to modify the color, and ultimately make a custom paint color based on the user's color selection. Furthermore, the paint code and tint formula used to create the custom paint color may be stored in conjunction with a user's profile on the kiosk, and may be used to make paint color recommendations to other users in the future.

Thus, methods, systems and computer program products are provided which determine a desired color for a home project and producing paint having the desired color through a kiosk at a point of sale location corresponding to a retail establishment. Moreover, methods, systems and computer program products are provided which determine a desired color for a home project and producing paint having the desired color.

As used in the specification, a word appearing in the singular encompasses its plural counterpart, and a word appearing in the plural encompasses its singular counterpart, unless implicitly or explicitly understood or stated otherwise. Furthermore, it is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise. In addition, unless otherwise indicated, numbers expressing quantities of ingredients, constituents, reaction conditions and so forth used in the specification and claims are to be understood as being modified by the term “about.”

Furthermore, as used in the specification and appended claims, directional terms, such as “top,” “bottom,” “left,” “right,” “up,” “down,” “upper,” “lower,” “proximal,” “distal” and the like are used herein solely to indicate relative directions and are not otherwise intended to limit the scope of the invention or claims.

In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) when referring to a specific instance of the element.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computerized method of determining a desired color for a home project and producing paint having the desired color through a kiosk at a point of sale location corresponding to a retail establishment, comprising:
receiving from a user at the kiosk, an indication of a particular paint color;
displaying to the user on a kiosk display a representation of the color corresponding to the indication of color;
receiving, by an input device of the kiosk, user input directed to altering the displayed color;
altering, by the kiosk, the displayed color based on the user input until a desired color is displayed;
determining, by the kiosk, a unique tint formula corresponding to the desired color; and
producing, by the kiosk, a paint code that can be used to create a paint having the desired color based on the tint formula.

2. The computerized method of claim 1, further comprising determining, by the kiosk, a display color that represents the particular paint color associated with the indication of paint color.

3. The computerized method of claim 1, wherein the desired color comprises a color that is not in a color palette.

4. The computerized method of claim 1, further comprising associating a different display color with each of a plurality of paint color indicators, the display colors being colors that when displayed on the display, reproduce the paint colors of the corresponding paint color indicators.

5. The computerized method of claim 1, further comprising associating the desired color with a stored user profile for future paint production.

6. The computerized method of claim 1, wherein the tint formula is determined based on an RGB code of the displayed color that corresponds to the indication of paint color.

7. The computerized method of claim 1, wherein the received indication of paint color comprises a paint chip, and wherein the paint chip is one of a plurality of paint chips that are specific to a single paint manufacturer.

8. The computerized method of claim 1, wherein the kiosk is configured to produce the paint specified by the paint code.

9. The computerized method of claim 1, wherein producing the paint code by the kiosk further comprises sending the paint code to a paint station that prepares the paint according to the paint code.

10. The computerized method of claim 9, wherein producing the paint code further comprises:
electronically transmitting to an automatic paint mixer at the paint station, by the kiosk, the tint formula corresponding to the desired color;
determining, by the paint mixer based on the tint formula, colors and amounts of pigments to add to a specified manufacturer's base paint formula to produce paint having the desired color; and
mixing, by the paint mixer, the determined colors and amounts of pigments with the base paint to produce the paint having the desired color.

11. The computerized method of claim 1, wherein the paint code is only valid for producing the desired color with a specified manufacturer's base paint formula.

12. A system for determining a desired color for a home project and producing paint having the desired color, comprising:
a computerized device positioned at a kiosk at a point of sale location corresponding to a retail establishment, the computerized device comprising a display and an input device, the computerized device being adapted to:
determine a paint color associated with a received paint color indicator;
determine a display color that represents the paint color associated with the received paint color indicator;
display the display color on the display;
receive user input via the input device directed to altering the displayed color and to indicating when a desired color is displayed;
alter the displayed color based on the user input until the desired color is displayed; and
determine a tint formula corresponding to the desired color; and
a paint mixer in electronic communication with the computerized device, the paint mixer being adapted to:
electronically receive the tint formula from the computerized device; and
produce a paint corresponding to the desired color based on the received tint formula.

13. The system of 12, wherein the computerized device and the paint mixer are both positioned at the kiosk.

14. The system of claim 12, further comprising a database that associates desired colors with corresponding users.

15. The system of claim 12, further comprising a database that associates display colors with corresponding paint color indicators, the display colors being different colors that, when displayed on the display, reproduce the paint colors of the corresponding paint color indicators.

16. The system of claim 12, wherein a plurality of paint color indicators are provided that are specific to a single paint manufacturer, and wherein the received paint color indicator is one of the plurality of paint color indicators.

17. The system of claim 12, wherein the produced tint formula is valid for base paints having a specified formula produced by the specified paint manufacturer.

18. A kiosk computer system comprising:
one or more processors;
a receiving module for receiving from a user at the kiosk, an indication of a particular paint color;
a display for displaying to the user a representation of the color corresponding to the indication of color;
an input device for receiving user input directed to altering the displayed color;
a color altering module for altering the displayed color based on the user input until the desired color is displayed;
a tint formula determining module for determining a tint formula corresponding to the desired color; and
a paint code producing module for producing a paint code that can be used to create a paint having the desired color based on the tint formula.

19. The kiosk computer system of claim 18, wherein the indication of paint color comprises at least one of the following: a paint chip, a color swatch, an image, a specified color within an image, and a home décor item.

20. The kiosk computer system of claim 18, wherein the input device comprises at least one of a mouse, a keyboard, a touchscreen, a barcode scanner, a photo spectrometer, and a wireless communication device that uploads images to the kiosk computer system.
